(19) United States
(12) Patent Application Publication
(10) Pub. No.: US 2001/0037226 A1
(43) Pub. Date: Nov. 1, 2001

(54) Method of making reservations and checking wait state for facility utilization

(76) Inventor: Makoto Kurokawa, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/842,649

(22) Filed: Apr. 27, 2001

(30) Foreign Application Priority Data
Apr. 27, 2000 (JP) 2000-126781

(51) Int. Cl. G06F 17/60

(52) U.S. Cl. 705/5

(57) ABSTRACT

When users make reservations for facility utilization from terminal equipment 101a through 101n in on the sides of the users, the reservations are completed by accessing home pages 109 through 111 of the intended facility to utilize via a main site 106 provided on a network 102 via a communication channel. And updating operations of the reservation data input by registered users such as deletions and the like are executed by accessing the home pages 109 through 111 from terminal equipment 103 through 105 on the sides of the facilities via the communication channel.

### BACKGROUND OF THE INVENTION

The present invention relates to a method of making a reservation for utilizing various kinds of facilities such as hospitals and the like and a method of checking the wait state of facility utilization.

Conventionally, in the event of utilizing a facility such as hospitals and the like, users of the facility have to make reservations in place and wait for their turns to come around, generally. Therefore, a problem is caused that the users have to wait for extremely long time after making reservations in the event that a waiting list of the facility runs long.

A method of checking the wait state of reservations and turns by phone for solving the above-mentioned problem is provided as a result.

As mentioned above, in the method of checking the wait state of reservations and turns, another problem that receptionists of the facilities are put enormous load is caused, in the event that many users try to make reservations and check the wait states by the above-mentioned methods.

### SUMMARY OF THE INVENTION

In the view of the foregoing problems of the conventional method mentioned above, it is therefore an object of the present invention to provide a method capable of making a reservation for facility utilization without putting loads on the receptionists of the facility and troubling the users to go to the facility.

And in the view of the foregoing problems of the conventional method mentioned above, it is therefore an object of the present invention to provide a method capable of checking the wait state of the facility without troubling the users to go to the facility.

According to the present invention, a method of making a reservation for facility utilization comprising the steps of;

making a reservation for facility utilization from terminal equipment on a side of a facility user;

registering data of the facility user in order of reception in a server in response to the above-mentioned reservation for facility utilization received via a communication channel;

giving an instruction for updating the data of the facility user to the above-mentioned server from a terminal equipment on a side of the facility via the communication channel; and

updating the above-mentioned instructed data of the facility user in the above-mentioned server is provided.

In the event of making a reservation for facility utilization from the terminal equipment on the side of the facility user, the data of the user is received via a communication channel and registered in a server in order of reception. And in the event that an instruction for updating the data of the facility user is given from terminal equipment on a side of the facility to the above-mentioned server via the communication channel, the instructed data of the facility users is updated.

Incidentally, the method may comprise providing a step of canceling the reservation of the user from the terminal equipment on the side of the user additionally.

And the steps of making reservations for facility utilization from the above-mentioned terminal equipment on the side of the user and giving an instruction for updating the data of the facility user from the terminal equipment on the side of the facility may be performed via home pages on the Internet.

Further, the method may comprise providing the steps of transmitting the waiting-time data of the facility user registered in the above-mentioned server and registering the waiting-time data of the above-mentioned facility user in the above-mentioned server from the above-mentioned terminal on the side of the facility via the communication channel.

And according to the present invention, a method of checking the wait state of facility utilization comprising the steps of;

making a reservation for the facility utilization from the terminal equipment on the side of the facility user;

registering data of the facility user in a server in order of reception in response to the above-mentioned reservation for facility utilization received via the communication channel;

giving an instruction for updating the data of the facility user to the above-mentioned server from the terminal equipment on the side of the facility via the communication channel;

updating the above-mentioned instructed data of the facility user; and

browsing the data of the facility user registered in the above-mentioned server from the above-mentioned terminal equipment on the side of the facility user is provided.

In the event of making a reservation for facility utilization from the terminal equipment on the side of the facility user, the data of the user is received via a communication channel and registered in a server in order of reception. And in the event that an instruction for updating the data of the facility user is given from terminal equipment on a side of the facility to the above-mentioned server via the communication channel, the instructed data of the facility users is updated. Further, the wait state of the facility utilization is checked by browsing the data of the users registered in the above-mentioned server from the above-mentioned terminal equipment on side of the facility user.

Incidentally, the steps of making reservations for facility utilization from the above-mentioned terminal equipment on the side of the user and giving an instruction for updating the data of the facility user from the terminal equipment on the side of the facility may be performed via home pages on the Internet.

Further, the method may comprise providing the steps of transmitting the waiting-time data of the facility user registered in the above-mentioned server and registering the waiting-time data of the above-mentioned facility user in the above-mentioned server from the above-mentioned terminal on the side of the facility via the communication channel.

### BRIEF DESCRIPTION OF THE DRAWINGS

FIG. 1 is a block diagram for showing a system used in methods of making reservations for facility utilization and checking the wait states of facilities relative to an embodiment of the present invention;

FIG. 2 is a diagram for showing a menu screen of a site relative to an embodiment of the present invention;

FIG. 3 is a diagram for showing a facility data inputting screen of a site relative to an embodiment of the present invention;

FIG. 4 is a diagram for showing a display screen on a home page relative to an embodiment of the present invention;

FIG. 5 is a diagram for showing a reservation inputting screen on a home page relative to an embodiment of the present invention;

FIG. 6 is a diagram for showing a reservation state displaying screen on a home page relative to an embodiment of the present invention;

FIG. 7 is a flowchart for illustrating a process of terminal equipment on a side of a facility user relative to an embodiment of the present invention;

FIG. 8 is a flowchart for illustrating a process of terminal equipment on a side of a facility user relative to an embodiment of the present invention;

FIG. 9 is a flowchart for illustrating a process of a server of a site relative to an embodiment of the present invention; and

FIG. 10 is a flowchart for illustrating a process of terminal equipment on a side of a facility relative to an embodiment of the present invention.

### DETAILED DESCRIPTION OF THE PRESENT EMBODIMENT

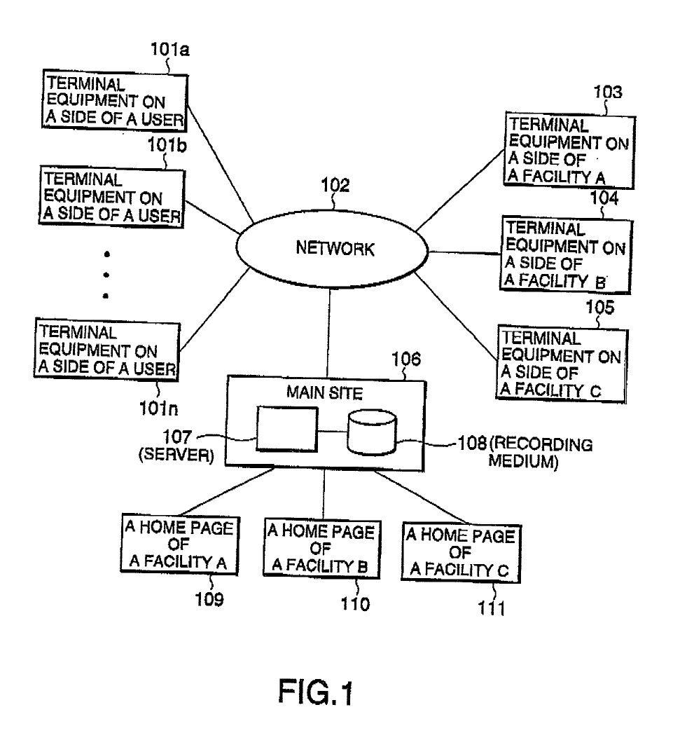

FIG. 1 is a block diagram for showing a system used in methods of making a reservation for facility utilization and checking the wait state of the facility utilization relative to an embodiment of the present invention.

In FIG. 1, the present system is composed of; a network 102 forming a communication channel and a plurality of terminal equipment 101a through 101n on the sides of facility users connected to the network 102,

a plurality of terminal equipment 103 through 105 on the sides of facilities,

a main site 106 on the network 102 for inputting reservations for facility utilizations and checking the wait state of the facility utilizations transmitted there-through, and

home pages 109 through 111 of facilities linked to the site 106. The main site 106 is composed of a main body of the server 107 having a central processing unit (CPU and a server (a Web server, in the event of the Internet) providing a recording medium 108 as storing means. The recording medium 108 is composed of a hard disc and the like, in which software programs provided for the main body of the server 107 to perform processes which will be mentioned below and data of the reservations for the facility utilizations are stored. The above-mentioned server has a processing function and a communicating function as will be mentioned below.

Information processing equipment such as personal computers, portable terminals, portable phones with information display function and the like are acceptable for the terminal equipment 101a through 101n on the sides of facility users. Each of the terminal equipment 101a through 101n on the sides of facility users has;

a function for displaying screen information of the site 106 provided on the network 102 and home page information linked thereto on a screen of own terminal equipment and

a function capable of required operations (choosing items, inputting numbers and the like) with respect to the home pages 109 through 111. That is, each of the terminal equipment 101a through 101n on the sides of facility users has a recording medium as storing means in which a CPU and software programs are stored and provides a processing function as well as a communicating function as will be mentioned below.

And each of the terminal equipments 103 through 105 on the sides of facilities A, B and C have the similar functions of displaying product information provided on the network 102 and home page information linked thereto on a screen of own terminal equipment and a function capable of required operations (choosing items, inputting numbers and the like) with respect to the home pages 109 through 111 as the terminal equipment 101a through 101n on the sides of the facility users. That is, each of the terminal equipment 103 through 105 on the sides of the facilities has a recording medium as storing means in which a CPU and software programs are stored and provides a processing function as well as a communicating function as will be mentioned below.

However, concerning to the information input and output on the screen, information available for inputting and outputting from the terminal equipment 101a through 101n on the sides of the facility users and the same from the terminal equipment 103 through 105 on the sides of facilities are different.

For example, users can only input or delete their own information (e.g., input of membership number of the user own) from the terminal equipment 101a through 101n. And the users can only output their own information (e.g., information about waiting time of the users). That is, the system is composed to restrict the terminal equipment 101a through 101n on the sides of facility users not to input and delete information of others and not to output information about waiting time that may show other's name.

On the other hand, all of the information such as personal information input by all the members (users), turns of inputting reservations and the like are output from the terminal equipment 103 through 105 on the sides of facilities. Further, the system has a composition in which operations of inputting reservations of all the members (users) and deleting the reservations from the waiting lists may be performed from the terminal equipment 103 through 105 on the sides of facilities.

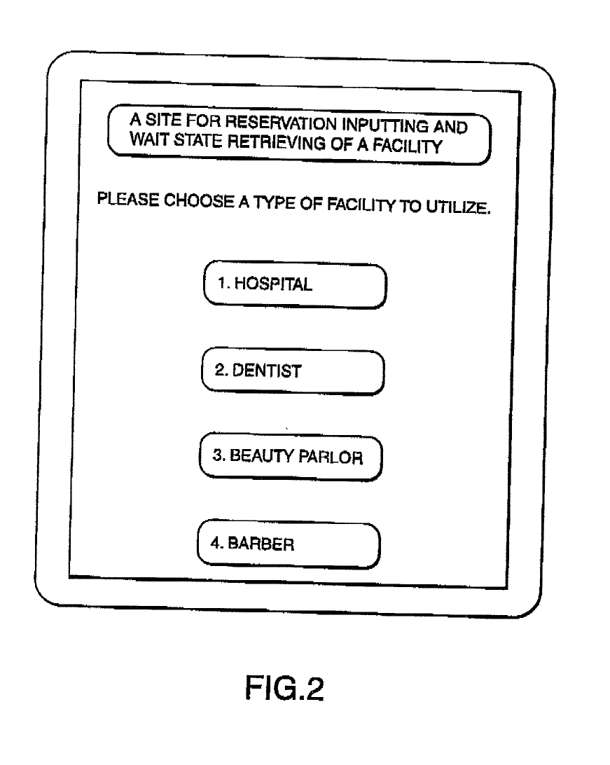

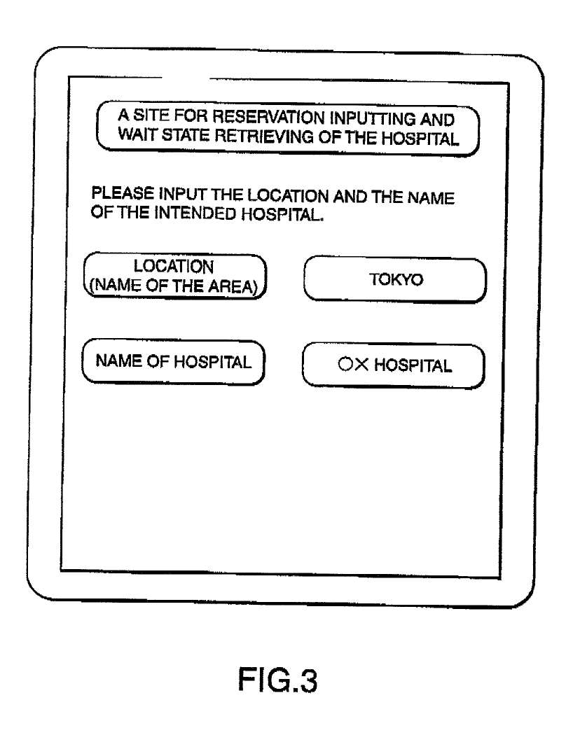

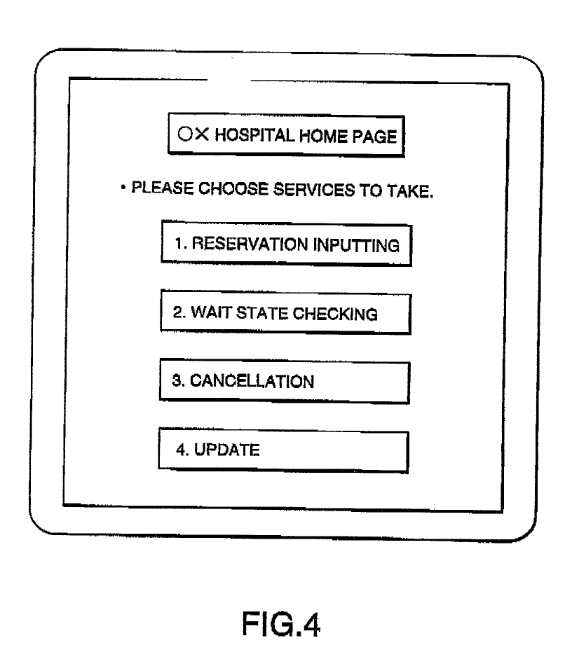

The site 106 has a function of connecting the accesses from the to the home pages of the facilities by choosing an intended facility on the pages, in which screens, for example, as shown in FIG. 2 and FIG. 3 are provided. In each home page of the facilities, functions for inputting reservations and checking the wait states are provided. The functions are generally programmed according to a specification specified by the site 16 and the operability thereof is unified. Examples of the functions are shown in FIGS. 4, 5 and 6. It is possible to compose the system providing two types of screens additionally in consideration of the event of displaying the home pages in terminal equipment with comparatively high resolution such as personal computers and the event of displaying them in terminal equipment with comparatively low resolution such as portable phones.

Here, the summary of the methods of making reservations for facility utilization and checking the wait states of the facilities relative to an embodiment of the present invention is described. Firstly, a home page available for making reservations for facility utilization and checking the wait states of the facilities such as hospitals, beauty parlors, restaurants and the like where the wait state may be caused is provided in a site on the Internet so that terminal equipment on both sides of users and facilities can access thereto. Thus, making reservations for facility utilization from terminal equipment on the sides of users and updating the wait state of the facility utilization whenever necessary from terminal equipment on the side of the facility may be possible. Accordingly, methods and systems for implementing making reservations for facility utilization and checking the wait states of the facilities without going to the pertinent facilities are provided.

Referring to FIG. 1, the processes of making a reservation and checking the wait state of the facility implemented by the methods and systems of the present invention will be described as follows. Usually, a user ‘a’ has to make a reservation in order to utilize a facility A (for example, a hospital, beauty parlor, restaurant and the like) and wait his or her turn to come around in the facility A. However, in an embodiment of the present invention, the user ‘a’ accesses to the site 106 for making a reservation and checking the wait state of the facility A on the network 102 by using terminal equipment 101a and reaches to a home page 109 of the facility A existing under the site 106. Then, the user ‘a’ executes a process of making a reservation for the facility A in the home page 109.

The information on the home page 109 may be updated in the process of making reservations input from the terminal equipment 101a through 101n of a plurality of other users intending to utilize the facility A and also updated by inputting new information from the terminal equipment 103 on a reception desk in the facility A (input for making reservations are executed from the terminal equipment 101a through 101n, on the other hand, update of the wait state is performed by the terminal equipment 108 on the side of the facility A by deleting the registration of a user in every time when the user on the wait list gets his or her turn and gets out of the list for utilizing the facility). Thus, the wait state of the facility utilization are changed in real time. And accordingly, it becomes possible for users intending to utilize the facility not only to make reservations without going to the facility but also to go to the facility at the right time by checking the wait state thereof.

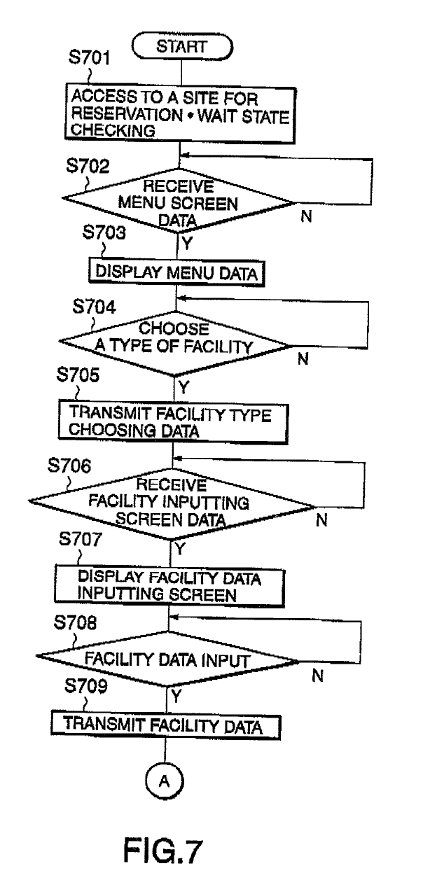

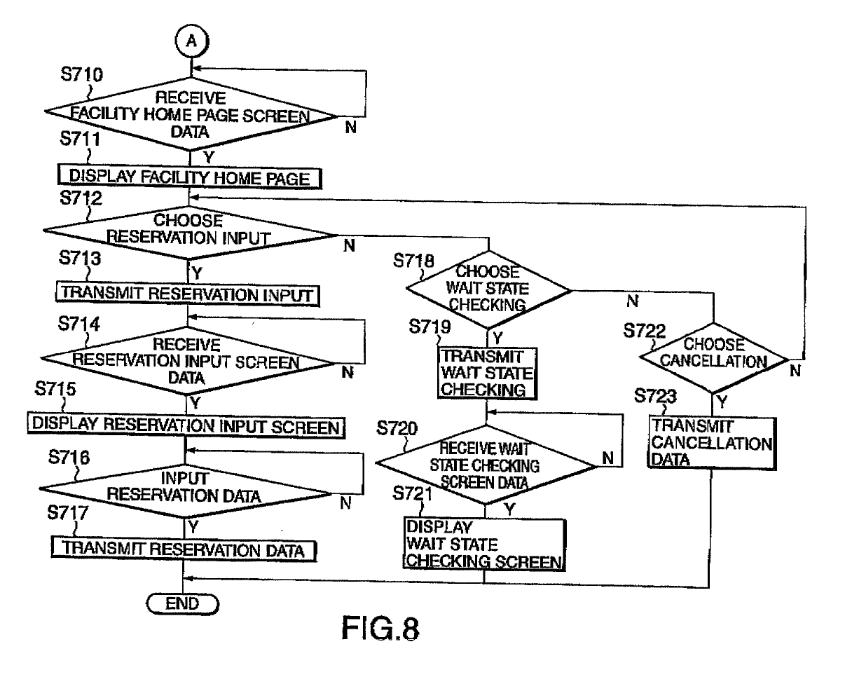

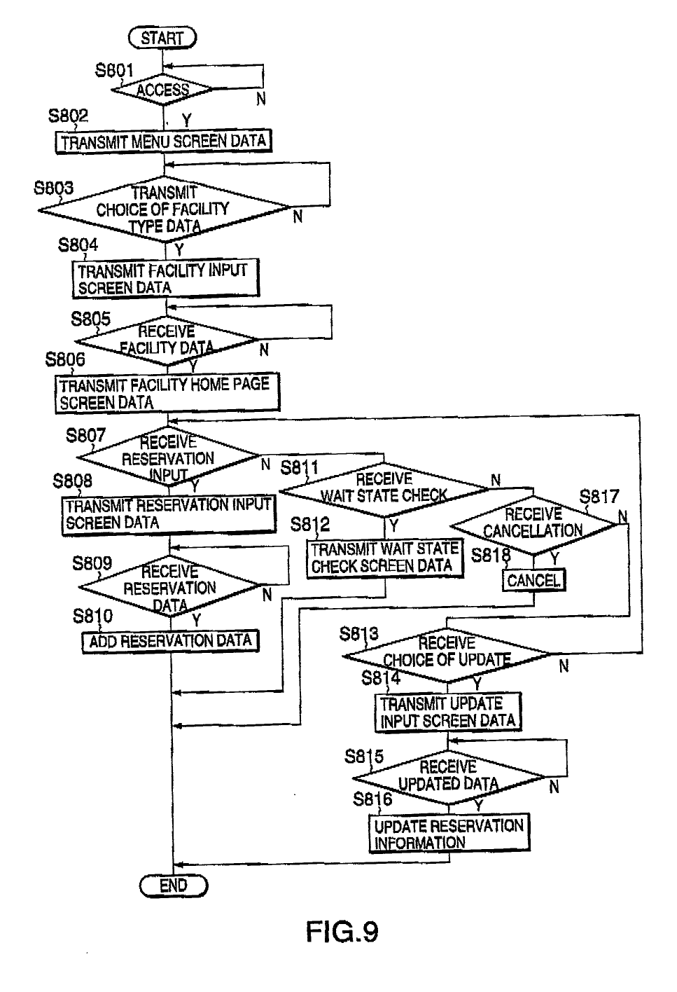

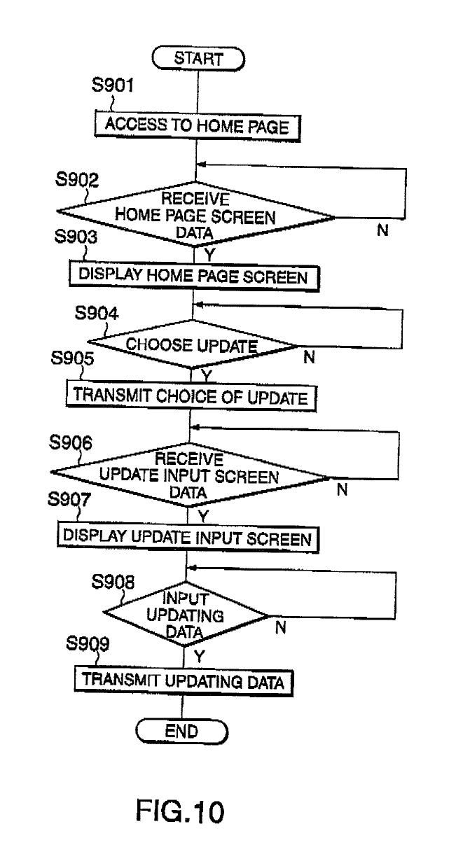

FIG. 7 and FIG. 8 are flowcharts for illustrating the processes of the terminal equipment 101a through 101n on the sides of users, and FIG. 9 is a flowchart for illustrating a process of the server composing the site 106. Further, FIG. 10 is another flowchart for illustrating a process of the terminal equipment 103 through 105 on the sides of the facilities.

Hereafter, detailed descriptions of embodiments according to the present invention will be made, referring to the drawings of FIG. 1 through FIG. 10. Incidentally, in the description below, an example of embodying the present invention in a hospital will be described. That is, the network 102 is assumed to be the Internet, the terminal equipment 103 on the side of the facility A to be terminal equipment on a reception desk in the hospital, the user ‘a’ to be a patient utilizing the hospital, and the terminal equipment 101a on the side of the user to be a personal computer of the user ‘a’. The user (patient) a makes a reservation for facility utilization from the terminal 101a and the reservation is updated by the facility (hospital) A from the terminal 103, in the example. In the same manner, making reservations and updating the reservations are performed by the terminal equipment 101b through 101n on the sides of other users and terminal equipment 104 and 105 on the sides of other facilities respectively.

Firstly, a user (patient) ‘a’ accesses to a main site 106 for inputting a reservation and checking the wait state of a facility via a communication channel such as telephone lines and the like from terminal equipment 101a on the users own side (step S701 in FIG. 7). When a server of the site 106 recognizes the reception of the above-mentioned access (step S801 in FIG. 9), data for displaying a menu screen as shown in FIG. 2 is transmitted to the terminal equipment 101a on the side of the user via the communication channel (step S802). Then the above-mentioned menu screen displaying data is received by the terminal equipment 101a on the side of the user (step S702) and the menu screen as shown in FIG. 2 is displayed on a display unit therein (step S703). A display advising the user to make a choice of facility type to utilize, for example, a hospital, a dentist, a beauty parlor and a barber, is indicated on the above-mentioned menu screen,

After that, when the user ‘a’ makes a choice of facility type, for example, a hospital, for his or her own utilization by clicking the screen using a mouse as inputting means of the terminal equipment 101a on the side of the user (step S704), facility type identifying data for identifying the type chosen by the user is transmitted from the terminal equipment 101a on the side of the user via the communication channel (step S705).

When the server of the site 106 recognizes the reception of the above-mentioned facility type identifying data (step S803), data of a facility data inputting screen for displaying a screen for inputting facility data as shown in FIG. 3 is transmitted to the terminal equipment 101a on the side of the user via the communication channel (step S804). The above-mentioned data of a facility data inputting screen (step S706) is received in the terminal equipment 101a on the side of the user and the facility data inputting screen as shown in FIG. 2 is displayed on a display unit therein (step S707). A display advising the user to input individual information for designating the name of facility to utilize, for example, a location (an address) of the facility (the hospital) or a name of the facility (a name of the hospital), is indicated in the above-mentioned facility data inputting screen.

And in the event that the user a inputs a facility data, for example, “Takyo” as an address and “∘×hospital” as a name of hospital for designating the facility (the facility A, in the present example) to the terminal equipment 101a on the side of the user by using a keyboard as inputting means (step S708), the facility data input by the user is transmitted from the terminal equipment 101a on the side of the user via the communication channel (step 709).

When the server of the site 106 recognizes the reception of the above-mentioned facility data (step S805), facility home page screen data as shown in FIG. 4 for displaying the home page of the facility A is transmitted to the terminal equipment 101a on the side of the user via the communication channel by accessing to the home page of the facility A (step S806). Incidentally, descriptions are made assuming that the home pages of the facilities A, B and C are provided in the server 106, in the present example.

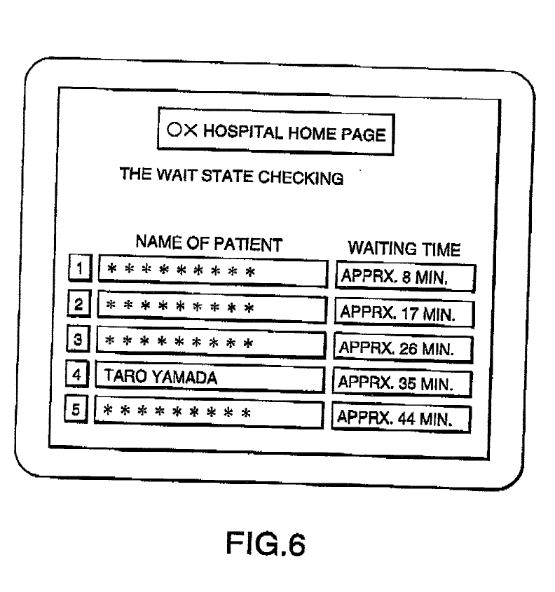

Then the above-mentioned facility home page screen data is received by the terminal equipment 101a on the users side (step S710) and the home page of the facility A as shown in FIG. 2 is displayed on a display unit therein (step S711). A display advising the users to make choices of types of services to utilize, for example, a choice of reservation inputting for making reservations for facility utilization, a choice of checking the wait state of the facility, a choices of cancellation that can be input by the user himself or herself from the terminal equipment on the side of the user's own, and a choice of update that can not be operated from the terminal equipment on the side of the user but can be operated only from the terminal equipment on the side of the facility for updating the reservation data, is displayed on the above-mentioned home page. Then, after making a reservation as will be mentioned, the user can check his or her turn on the wait state checking screen (FIG. 6) by clicking a mouse on the item of “the wait state checking” so that the user can determine the right time to go to the hospital.

Incidentally, when the user wants to make a cancellation of a registered reservation, a predetermined registered password (for example, a password for making an access to the site 106) for choosing an item of “cancellation” is required. And the item of cancellation is provided so that the user can choose for canceling the reservation from the terminal equipment 101a through 101n. In the same manner, when the user wants to update the reservation data, a predetermined registered password (for example, a password for making an access to the site 106) for choosing an item of update is required. However, an updating operation may be executed only by the terminal equipment 103 on the facility side, but not from the terminal equipment 101a on the user's side.

Next, in the event the user ‘a’ chooses an item of “reservation inputting” for making a reservation for facility utilization by using a mouse (step S712), a signal for signifying that reservation inputting has been chosen is transmitted to the server (step S713).

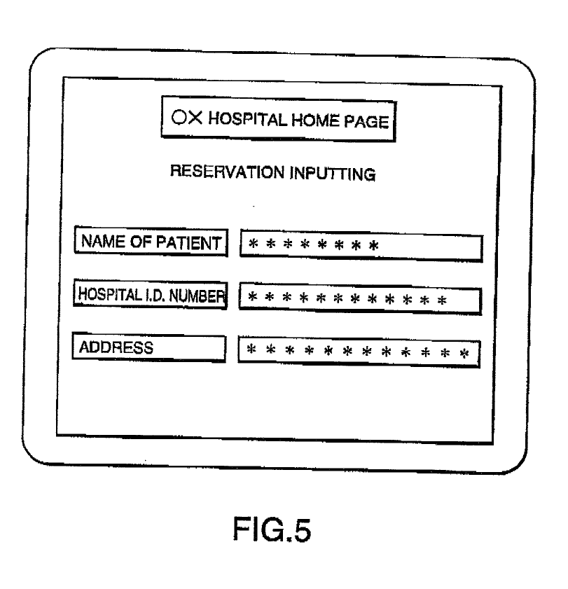

When the server of the site (the site 106, in the present example) of the above-mentioned home page recognizes the reception of the above-mentioned signal of the reservation inputting (step S807), reservation inputting screen data for displaying a reservation inputting screen of the facility A as shown in FIG. 5 is transmitted to the terminal equipment 101a on the side of the user via the communication channel (step S808). The terminal equipment 101a on the side the user receives the above-mentioned reservation inputting screen data of the facility (step S714) and displays the reservation inputting screen for making a reservation for utilizing the facility A as shown in FIG. 5 on a display unit therein (step S715).

Then a display advising the users to input information for identifying the user himself or herself, for example, a name and an address of the user (patient) and an identification number of the patient written on an I.D. card of the pertinent hospital, is displayed on the above-mentioned reservation inputting screen. However, as the information input to the screen is required only for identifying the user, in the event the user has ever been to the pertinent facility (hospital) and given a code (a number given to the patient written on the hospital I.D. card, in the present example) for identifying the user, the user only have to input the above-mentioned code, but the name or the address.

Next, in the event that the user ‘a’ inputs a reservation data for identifying the user ‘a’ himself or herself to make a reservation by using a keyboard as inputting means (step S716), the above-mentioned reservation data is transmitted from the terminal equipment 101a on the side of the user via the communication channel (step 717).

When the server of the site (the site 106, in the present example) of the above-mentioned home page recognizes the reception of the above-mentioned reservation data (step S809), the received reservation data is added at the tail end of the patients names on the waiting list on the home page (step 810).

As it has been mentioned above, when the reservation from the user (patient) ‘a’ is received, the reservation of the user (patient) ‘a’ is added and indicated at the tail end of the waiting list data of the users (patients). Accordingly, a reservation for consulting a doctor of the present day is made and the process for making a reservation for utilizing a facility (a hospital, in the present example) is completed by processing all the steps of S701 through S717 in the terminal equipment 101a on the side of the user and steps of S810 through S810 in the server of the home page 109.

Hereafter, a method of checking the wait sate of the reservation for facility utilization from the terminal equipment on the side of the user will be described as follows.

Before proceeding the steps, the terminal equipment 101a on the side of the user is assumed to be in a state of displaying the screen as shown in FIG. 4, that is, processes down to the step S711 in FIG. 8 has been completed by connecting the access from the terminal equipment 101a on the user side to the home page of the facility A via the main site 106 in the above-mentioned manner.

In the above-mentioned state, when the user ‘a’ makes a choice of checking the wait state for the facility utilization by clicking a mouse on the item of “wait state checking” (step S718), a signal for signing that the above-mentioned “wait state checking” has been chosen is transmitted from the terminal equipment 101a on the side of the user via the communication channel (step S719).

When the server of the site (the site 106, in the present example) of the above-mentioned home page recognizes the reception of the signal signing the above-mentioned wait state checking is chosen (step S811), data of the wait state checking screen for indicating the state of reservation as shown in FIG. 6 is transmitted to the terminal equipment 101a on the side of the user via the communication channel (step S812). The terminal equipment 101a on the side of the user receives the above-mentioned data of the wait state checking screen (step S720) and displays the wait state checking screen as shown in FIG. 6 on a display unit therein (step S721). Thus, the user a can check his or her turn in the wait state of the facility (hospital) A by processing all the steps of S708 through S721 in the terminal equipment 101a on the side of the user and processing the steps of S811 and S812 in the server of the home page 109.

Incidentally, a display screen for showing the reservation state on the home page in FIG. 6 is an example of a display in the event that a user accessing to the home page is “Taro Yamada”. In the terminal equipment 101a through 101n on the sides of the users, only the name of the user himself or herself who made an operation is indicated and names of other users are indicated by “* (an asterisk)” in order to maintain confidentiality of information of the users who made reservations. In FIG. 6, names and the wait states of each user (patient) are indicated in order of reception. Further, the display shown in FIG. 6 indicates that the user (patient) “Taro Yamada” is fourth on the waiting list and has waiting time of approximately 35 minutes.

Hereafter, a processing method in the event of canceling a reservation previously made by the user ‘a’ from the terminal equipment 101a on the user side.

Before proceeding the steps, the terminal equipment 101a on the side of the user is assumed to be in a state of displaying the screen as shown in FIG. 4, that is, processes down to the step S711 in FIG. 8 has been completed by connecting the access from the terminal equipment 101a on the user side to the home page of the facility A via the main site 106 in the above-mentioned manner.

In the above-mentioned state, when the user makes a choice of a reservation cancellation by clicking a mouse on the item of “cancellation” (step S722), cancellation data for canceling a reservation of the user is transmitted from the terminal equipment 101a on the side of the user via the communication channel (step S723).

When the server of the site (the site 106, in the present example) of the above-mentioned home page recognizes the reception of the cancellation data (step S817), the reservation data of the pertinent user is deleted so that the reservation is cancelled (step S818). Thus, the reservation made by the user ‘a’ is cancelled. As it has been mentioned above, the user a can cancel the reservation by processing the steps of S722 and S723 in the terminal equipment 101a on the user side and processing the steps of S817 and S818 in the server of the home page 109.

Hereafter, a processing method of checking and updating the reservation states in the facility from the terminal equipment 108 through 105 on the sides of facilities will be described.

Firstly, a staff of the facility accesses to the main site 106 from the terminal equipment 103 on the side of the facility in the same manner as the terminal equipment 101a on the side of the user and reaches to the home page of the facility A (step S901 in FIG. 10). Tho server of the site (the site 106, in the present example) in the home page of the facility A transmits a home page screen data of the facility A to the terminal equipment 103 on the sides of the facility via the communication channel (step S816). The terminal equipment 103 on the sides of the facility receives the data (step S902) and displays the screen as shown in FIG. 4 (step S903).

In the above-mentioned state, when a receptionist of the facility A makes a choice of updating the wait state of the facility utilization by clicking a mouse on the item of “update” in the FIG. 4 (step S904), a signal signifying that update is chosen is transmitted from the terminal equipment 103 on the side of the facility via the communication channel (step S905).

When the server of the site (the site 106, in the present example) of the above-mentioned home page recognizes the reception of the signal signifying the choice of the above-mentioned item of “update” (step S813), update inputting screen data for updating the data of the users on the waiting list is transmitted to the terminal equipment 103 on the side of the facility via the communication channel (step S814). The terminal equipment 103 on the side of the facility receives the above-mentioned update inputting screen data (step S906) and displays the update inputting screen of the facility A of generally identical contents as FIG. 6 on a display unit (step S907). Incidentally, names of other users except for the pertinent user are indicated by “* (an asterisk)” in FIG. 6, but all the names of the users are indicated in the terminal equipment 103 on the facility side.

Accordingly, the wait state of all patients can be checked at the reception desk in the facility (hospital) A And the users (patients) are admitted to a consulting room in order of the waiting list. After the first user (patient) goes into the room, the name of the user (patient) is deleted from the waiting list of the reservations and the rest of the names in the waiting list are move up by room for one person.

That is, a process of updating the reservation data is executed by operating a mouse and a keyboard of the terminal equipment 103 on the facility side in the state that the names of all the users are indicated thereon. An operation of updating the reservation data includes a deletion of the reservation data of the patients whose data has been proceeded to an end by an admittance to the consulting room or whose data has been canceled at the reception desk in the facility, an addition of reservation data of the patients who made reservations by phone or at the reception desk in the facility, a revision of waiting time data and the like. When the above-mentioned updating process is executed by inputting an updating data (step S908), an updated data is transmitted from the terminal equipment 103 on the side of the facility via the communication channel (step S909).

When the server of the site (the site 106, in the present example) in the above-mentioned home page recognizes the reception of the above-mentioned updated data (step S815), updating processes of deletions, additions, revisions and the like of the reservation data are performed so that the wait state data of the reservations in the facility A is consistent with the above-mentioned updated data (step S816).

As it has been mentioned above, the staff of the pertinent facility can execute processes of checking and updating the reservation state in the facility from the terminal equipment 103 on the side of the facility by processing the steps of S901 through S909 in the terminal equipment 103 on the side of the facility and by processing the steps of S813 through S816 in the server on the side of the home page.

As it has been described above, the methods of making reservations for facility utilization relative to the present embodiment comprise steps of;

making reservations for facility utilization from the terminal equipment 101a through 101n on the sides of the users,

registering data of the users who made reservations in the server in order of reception in response to the above-mentioned reservations via communication channels such as telephone lines or a network and the like,

instructing the updating operations such as deletions, additions and the like of the registered data of the users in the above-mentioned server via the communication channels such as telephone lines or network and the like from the terminal equipment 103 through 105 on the sides of the facilities, and

executing updating operations such as deletions, additions and the like of the above-mentioned instructed data of the users from and to the above-mentioned server. And the methods also include a step of canceling the reservations of the pertinent users who made reservations for facility utilization from the terminal equipment 101a through 101n on the sides of the users. The methods further include steps of instructing cancellations of the reservations of the pertinent users from the terminal equipment 101a through 101n on the sides of the users and canceling the reservations of the pertinent users in the above-mentioned server. Further more, reservations for facility utilization made from the terminal equipment 101a through 101n and instructions for updating the data of the registered users by deletions and the like given from the terminal equipment 103 through 105 on the sides of the facility are operated via the home pages 109 through 111 on the Internet, in the methods. And the methods include steps of transmitting the wait state data of the users registered in the above-mentioned server from the terminal equipment 103 through 105 on the sides of the facilities to the above-mentioned server via the communication channels and registering the wait state data of the above-mentioned users in the above-mentioned server.

Further, the methods of checking the wait state of facility utilization relative to the present embodiment comprise steps of;

making reservations for facility utilizations from the terminal equipment 101a through 101n on the sides of the users,

registering data of the users who made reservations in the server in order of reception in response to the above-mentioned reservations via communication channels such as telephone lines or network and the like,

instructing the updating operations such as deletions, additions and the like of the registered data of the users in the above-mentioned server via the communication channels such as telephone lines or network and the like from the terminal equipment 103 through 105 on the sides of the facilities,

executing updating operations such as deletions, additions and the like of the above-mentioned instructed data of the users from and to the above-mentioned server, and

browsing users' data registered in the server from the terminal equipment 101a through 101n on the sides of the users. And reservations for facility utilization made from the terminal equipment 101a through 101n on the sides of the users and instructions for updating the data of the registered users by deletions and the like given from the terminal equipment 103 through 105 on the sides of the facilities are executed via the home pages 109 through 111 on the Internet, in the methods. Further, the methods include steps of transmitting the wait state data of the users registered in the above-mentioned server from the terminal equipment 103 through 105 on the sides of the facilities to the above-mentioned server via the communication channels and registering the wait state data of the above-mentioned users in the above-mentioned server.

Therefore, the users (patients, in the present example) can avoid troubles of going all the way to particular facilities to make reservations and waiting their turns for long time. And the users can complete making reservations for facility utilization and wait for their turns coming around in any places such as their home and the like wherever the users can access to the Internet.

Thus, it becomes possible to save spaces in the waiting room, parking area and the like, because the users waiting for their turns are reduced extremely.

And the present invention makes a large extent of contributions for the facilities to attract users by providing a great many advantages.

Further, advertisements on the home pages 109 through 111 bring about a great effect in advertising the facilities, because users access to the main site 106 and the above-mentioned home pages for making reservations and checking the wait states frequently.

Incidentally in the present embodiment, waiting lists are arranged on first-come, first-served basis of the present day. However, a method for making a reservation by specifying the date and time can be employed. In the above-mentioned event, the reservations are registered at each specified date and time in order of the reception.

And not only personal computers but also portable phones, portable terminals and the like are acceptable as terminal equipment 101a through 101n on the sides of the users.

Further, the methods are applicable not only for hospitals but also dentists, beauty parlors, restaurants and the like as facilities where the wait state may be caused.

According to the present invention, it becomes possible for users of facilities to make reservations and to check the wait states without burdening staffs corresponding to the reservations in the facilities and without going to the facilities to make reservations, Therefore, a situation of waiting turns in the facilities for long time may be avoided to from causing to the users of the facilities. And cancellations and updating of the reservations can be performed easily.

What is claimed is;

1. A method of making a reservation for facility utilization comprising the steps of;
making a reservation for facility utilization from terminal equipment on a side of a facility user;
registering data of the facility user in a server in order of reception in response to said reservation for facility utilization received via a communication channel;
giving an instruction for updating the data of the facility user to said server from terminal equipment on a side of the facility via the communication channel; and
updating said instructed data of the facility user in said server.

2. A method of making a reservation for facility utilization as claimed in claim 1, further comprising the step of canceling own reservation from said terminal equipment on the side of the facility user.

3. A method of making a reservation for facility utilization as claimed in claim 1, wherein the reservation made from the sad terminal equipment on the side of the facility user and the instruction for updating the data of the facility user given from said terminal equipment on the side of the facility are performed via home pages on the Internet.

4. A method of making a reservation for facility utilization as claimed in claim 2, wherein the reservation made from the said terminal equipment on the side of the facility user and the instruction for updating the data of the facility user given from said terminal equipment on the side of the facility are performed via home pages on the Internet.

5. A method of checking the wait sate of facility utilization as claimed in claim 1, further comprising the steps of;
transmitting data of waiting time of the facility user registered in said server from said terminal on the side of the facility to said server via the communication channel and
registering said data of waiting time of the facility user in said server.

6. A method of checking the wait sate of facility utilization as claimed in claim 2, further comprising the steps of;
transmitting data of waiting time of the facility user registered in said server from said terminal on the side of the facility to said server via the communication channel and
registering said data of waiting time of the facility user in said server.

7. A method of checking the wait sate of facility utilization as claimed in claim 3, further comprising the steps of;
transmitting data of waiting time of the facility user registered in said server from said terminal on the side of the facility to said server via the communication channel and
registering said data of waiting time of the facility user in said server.

8. A method of checking the wait state of facility utilization comprising the steps of;
making a reservation for facility utilization from terminal equipment on a side of a facility user;
registering data of the facility user in a server in order of reception in response to receiving said reservation for facility utilization via a communication channel,
giving an instruction fox updating the data of the facility user to said server from terminal equipment on a side of a facility via the communication channel, updating said instructed data of the facility user, and
browsing the data of the facility user registered in said server from said terminal equipment on the side of the facility user.

9. A method of checking the wait state of facility utilization as claimed in claim 8, wherein the reservation made from the said terminal equipment on the side of the facility user and the instruction for updating the data of the facility user given from said terminal equipment on the side of the facility are performed via home pages on the Internet.

10. A method of checking the wait state of facility utilization as claimed in claim 8, further comprising the steps of;
transmitting waiting-time data of the facility user registered in said server from said terminal on the side of the facility to said server via the communication channel and
registering said waiting-time data of the facility user in said server.

11. A method of checking the wait state of facility utilization as claimed in claim 9, further comprising the steps of;
transmitting waiting-time data of the facility user registered in said server from said terminal on the side of the facility to said server via the communication channel and
registering said waiting-time data of the facility user in said server.
